(19) United States
(12) Patent Application Publication
(10) Pub. No.: US 2015/0203021 A1
(43) Pub. Date: Jul. 23, 2015

(54) RETAINING NET FOR INSTALLATION ON A FASTENING SURFACE

(71) Applicant: NOELLE PEPIN GMBH & CO. KG, Schwelm (DE)

(72) Inventor: Mark Emde, Emepetal (DE)

(21) Appl. No.: 14/419,960

(22) PCT Filed: Sep. 19, 2013
(86) PCT No.: PCT/EP2013/002825

§ 371 Date: Feb. 6, 2015

(30) Foreign Application Priority Data
Oct. 5, 2012 (DE) 20 2012 009 544.7

(51) Int. Cl. B60P 7/08

(52) U.S. Cl. CPC B60P 7/0876

(57) ABSTRACT

In the case of a retaining net for installation on a fastening surface, an elastic net part is provided, the net meshes of which are formed by assemblages of strands running at an inclination to one another and each having a plurality of net strands. In order to configure such a retaining net in such a manner that, in the fitted state of the retaining net or of the net part, a more uniform mesh structure is achieved than in the prior art and sagging at the edges is very substantially avoided, it is proposed that, in the non-fitted state of the net part, the net meshes in the edge regions of the net part are smaller than in central regions of same, and that, in in the fitted state of the net part, the net meshes are the same size in the edge regions and in the central regions of said net part.

The invention relates to a stowage net for installation on a mounting surface, with elastic netting whose meshes are formed by strand groups, running inclined at an angle to one another, in each case having a plurality of netting strands.

In such stowage nets of known art the effect occurs that when the elastic netting is installed on the mounting surface a non-uniform mesh structure develops over the surface of the netting, and sagging occurs in the edge regions of the netting.

Based on the prior art as depicted above, the task underlying the invention is that of providing a stowage net for installation on a mounting surface, in which in the installed state of the stowage net, or netting, a more uniform mesh structure is achieved, and sagging at the edges is avoided as far as possible.

In accordance with the invention this task is achieved such that in the uninstalled state of the netting the meshes in the edge regions of the netting are smaller than in the central regions of the same, and such that in the installed state of the netting the meshes in the edge and central regions of the same are of equal size. In accordance with the invention a mesh structure of the netting is obtained in which the meshes in central regions of the netting and in edge regions of the same match one another with regard to their dimensions. By this means a mesh structure of the netting of the inventive stowage net is achieved that is as uniform as possible. Since in the uninstalled state of the stowage net the meshes at the edges of the netting are smaller than in the central regions of the netting, in the installed state of the netting, or stowage net, the smaller meshes in the edge regions of the netting provide a greater stiffening of this local region of the netting, or net structure, than the larger meshes do in the central regions of the netting, or net structure. By this means a significant reduction in sagging is achieved in the edge regions of the netting, or net structure, whereby, moreover, a more uniform mesh structure ensues over the surface of the netting.

An even more uniform design of the mesh structure of the netting, or net structure, is achieved if, in the uninstalled state of the netting, the meshes are designed to be ever smaller from the center in the outward direction up to the edge of the same, and, in the installed state of the netting, the meshes are of equal size over the whole of the netting. The specification for the dimensions of the meshes takes place as a function of the position of the mesh in question within the netting, or net structure, and also as a function of the parameters that are determined by the installation of the netting, or stowage net.

In accordance with an advantageous form of embodiment of the inventive netting the meshes of the netting, or net structure, are designed to be diamond-shaped.

The inventive stowage net can be designed as a floor net, as a frame net, for example as a plastic or wire frame net, as a strip net, for example as a plastic strip net, as a net with an elastic edge, for example as a rubber-edged net, or similar.

In one form of embodiment elastic netting of an inventive stowage net is provided with meshes that are configured in a diamond shape. These diamond-shaped meshes are formed by strand groups running inclined at an angle to one another, each consisting of a plurality of netting strands.

In the uninstalled state of the netting, or net structure, the diamond-shaped mesh arranged centrally in the same has dimensions that are greater than the dimensions of meshes that are adjacent to this mesh and arranged further outward. The further a diamond-shaped mesh of the netting, or net structure, is displaced from the center toward the edge regions of the netting, or net structure, the smaller are its dimensions.

The ratio of the dimensions between the diamond-shaped meshes is selected such that the parameters associated with the installation of the netting on the stowage net, and/or of the stowage net on the mounting surface, are taken into account as a function of the material of the elastic netting. The result is that in the installed netting, or installed stowage net, the mesh structure of the netting is as uniform as possible over the whole of the netting. Sagging on the edge regions of the stowage net, or netting, is avoided. In the installed state the size of the diamond-shaped meshes in the edge regions of the netting, or net structure, corresponds to the dimension of the diamond-shaped mesh in the central region of the netting, or net structure.

The inventive stowage net can be designed as a floor net, as a frame net, for example as a plastic or wire frame net, as a strip net, for example as a plastic strip net, as a net with an elastic edge, for example as a rubber-edged net, or in a similar manner.

The inventive stowage nets are particularly suitable for deployment in the automotive industry. Equivalent stowage nets can also be deployed in aircraft, ships, or similar.

1. A stowage net for installation on a mounting surface, with elastic netting whose meshes are formed by strand groups, running at an angle to one another, in each case having a plurality of netting strands, wherein, in the uninstalled state of the netting the meshes in the edge regions of the netting are smaller than in the central regions of the same, and in the installed state of the netting the meshes in the edge regions and the central regions of the same are of equal size.

2. The stowage net in accordance with claim 1, wherein in the uninstalled state of the netting, the meshes are designed to be ever smaller from the center in the outward direction up to the edge of the same, and in the installed state of the netting the meshes are of equal size over the whole of the netting.

3. The stowage net in accordance with claim 1, wherein the meshes of the netting are designed to be of a diamond shape.

4. use of the stowage net in accordance with claim as a floor net, plastic or wire frame net, as a plastic strip net, or as a rubber-edged net.
